(19) United States
(12) Patent Application Publication
(10) Pub. No.: US 2018/0260790 A1
(43) Pub. Date: Sep. 13, 2018

(54) AUTOMATED APPOINTMENT SCHEDULING

(71) Applicant: TimeTrade Systems, Inc., Tewksbury, MA (US)

(72) Inventors: Steven Connolly, Tewksbury, MA (US); Chris Gilmore, Tewksbury, MA (US)

(21) Appl. No.: 15/894,033

(22) Filed: Feb. 12, 2018

Related U.S. Application Data
(60) Provisional application No. 62/468,104, filed on Mar. 7, 2017.
(60) Provisional application No. 62/468,111, filed on Mar. 7, 2017.

(51) Int. Cl. G06Q 10/10

(52) U.S. Cl. CPC G06Q 10/1095

(57) ABSTRACT

In one example embodiment, a scheduling server creates a meeting invitation template that identifies multiple options for a parameter of a meeting. The scheduling server determines that a triggering condition for the meeting invitation template has occurred and, in response to the triggering condition occurring, sends, to a client device, a scheduling page that identifies the multiple options for the parameter of the meeting. The scheduling server receives, from the client device, a selection of one of the multiple options for the parameter of the meeting, and redirects the client device to a meeting status page that provides a link to the meeting.

### CROSS REFERENCE TO RELATED APPLICATION

This application claims priority to U.S. Provisional Application No. 62/468,104, filed Mar. 7, 2017, and to U.S. Provisional Application No. 62/468,111, filed Mar. 7, 2017. Both of these applications are incorporated herein by reference in their entireties.

### TECHNICAL FIELD

The present disclosure relates to web-based calendar/appointment systems.

### BACKGROUND

Professionals throughout various industries often spend excess time and resources manually organizing meetings with colleagues and/or customers, finding a time that works for all attendees, informing attendees of any relevant conferencing logistics, etc. Coordination of appointments is often needed throughout business processes (e.g., from lead generation through customer launch). For example, a user must frequently navigate back and forth between different calendar and/or customer relationship management (CRM) systems. As such, appointment coordination can be a time consuming and frustrating task. Such conferencing organization is inefficient and negatively impacts productivity.

### BRIEF DESCRIPTION OF THE DRAWINGS

FIG. 1 is a block diagram of a system configured for automated appointment scheduling, in accordance with examples presented herein.

FIG. 2 illustrates a create meeting invitation page, in accordance with examples presented herein.

FIG. 3 illustrates a customer scheduling page, in accordance with examples presented herein.

FIG. 4 illustrates a meeting status page, in accordance with examples presented herein.

FIG. 5 illustrates a meeting invitation, in accordance with examples presented herein.

FIG. 6 is a block diagram of a scheduling server, in accordance with examples presented herein.

FIG. 7 is a flowchart of a method for automated appointment scheduling, in accordance with examples presented herein.

### DESCRIPTION OF EXAMPLE EMBODIMENTS

### Overview

In one example embodiment, a scheduling server creates a meeting invitation template that identifies multiple options for a parameter of a meeting. The scheduling server determines that a triggering condition for the meeting invitation template has occurred and, in response to the triggering condition occurring, sends, to a client device, a scheduling page that identifies the multiple options for the parameter of the meeting. The scheduling server receives, from the client device, a selection of one of the multiple options for the parameter of the meeting, and redirects the client device to a meeting status page that provides a link to the meeting.

### Detailed Description

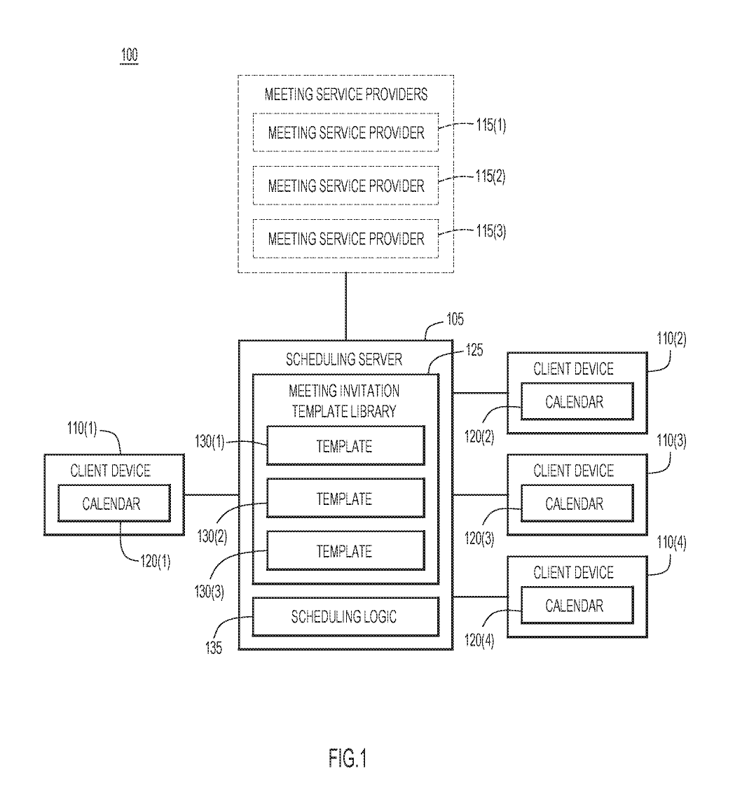

FIG. 1 is a block diagram of an example customer relationship management (CRM) system 100 configured for automated appointment scheduling. System 100 includes a scheduling server 105 in communication with client devices 110(1)-110(4) and, optionally, meeting service providers 115(1)-115(3). Client device 110(1) is operated by a meeting organizer, and client devices 110(2)-110(4) are each operated by respective meeting attendees.

Client devices 110(1)-110(4) include respective calendar applications (“calendars”) 120(1)-120(4). In one example, calendar 120(1) is a calendar for the meeting organizer, and calendars 120(2)-120(4) are calendars for the respective meeting attendees. Scheduling server 105 includes a meeting invitation template library 125, which stores meeting invitation templates 130(1)-130(3). Scheduling server 105 further includes scheduling logic 135 to perform operations described herein.

The meeting organizer (user of client device 110(1)) is a meeting attendee associated with an organization. In one example, at least one of the meeting attendees (users of client devices 110(2)-110(4)) are also associated with the organization, and the rest of the meeting attendees are external to the organization. For a variety of reasons, meetings occur between the meeting attendees associated with the organization and the meeting attendees external to the organization. In one example, the external meeting attendees are current or prospective customers of the organization. The scheduling server 105 may store information designating the meeting attendees as internal or external to the organization.

Initially, the scheduling server 105 may create meeting invitation templates 130(1)-130(3). The meeting invitation templates 130(1)-130(3) may be unique to the organization and affiliated with common meeting scenarios. The meeting invitation templates 130(1)-130(3) may identify multiple options for a parameter of the meeting, such as duration, relative date range, relative time, required meeting attendees, location information (e.g., room), time zone, required documents, meeting name, web conferencing details/conference line/collaboration software, notes, internal pooled resources, etc.

The date range and time may be relative to the date that the invitee opens the invitation. For instance, a meeting invitation may include a date range specifying dates and times for the meeting between Monday and Friday. However, if the meeting invitee opens the meeting invitation on Thursday, the meeting invitation may only display the meeting dates and times for Thursday and Friday. In another example, a meeting invitation may include a relative date range of one week, such that if the meeting invitation is sent on a Monday and opened on Thursday, the meeting invitation will display time slots between Thursday and the following Wednesday.

The scheduling server 105 may create the meeting invitation templates 130(1)-130(3) in response to user (e.g., administrator) prompts/instructions. The user may define the meeting invitation templates 130(1)-130(3) with an easily identifiable name (e.g., “Customer Launch Meeting”). Upon the creation of the meeting invitation templates 130(1)-130(3), the scheduling server 105 may store the meeting invitation templates 130(1)-130(3) (e.g., in meeting invitation template library 125). The user may update the meeting invitation template library 125 with new meeting invitation templates as new invitation scenarios are determined.

A meeting invitation template (e.g., meeting invitation template 130(1)) may further identify a particular meeting service provider (e.g., meeting service provider 115(1)) to host the meeting. For example, the organization (or a meeting attendee) may have an active subscription to, and corresponding user credentials for, meeting service provider 115(1). The scheduling server may store user credentials that cause the meeting service provider 115(1) to host the meeting, thereby enabling creation of a unique web conference upon request.

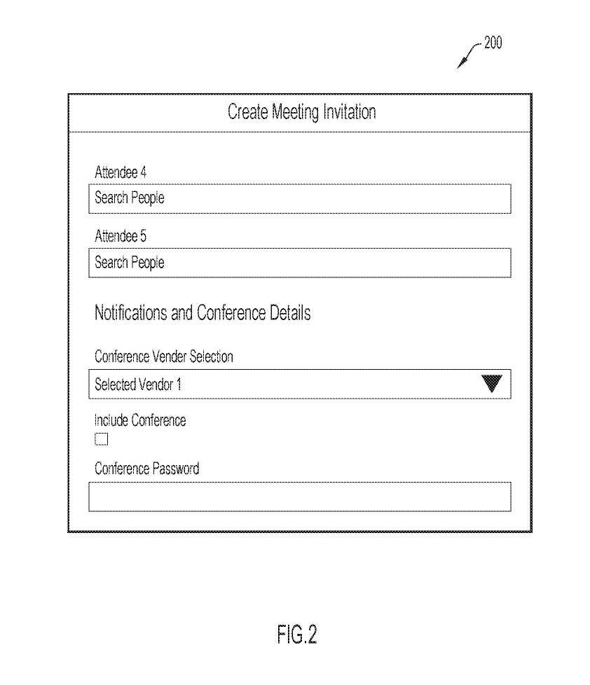

As an alternative to creating a meeting invitation template, the meeting organizer may manually create a meeting invitation using a create meeting invitation page 200, as illustrated in FIG. 2. As shown, a user may input preferences including invited attendees/participants, preferred meeting service provider (e.g., selected from a predefined group of third party service providers), password for the conference service, etc. The user may indicate that the meeting requires a conference line established and selected from a list of approved vendors that are pre-installed within the CRM system. Meeting invitation templates 130(1)-130(3) may also include this information.

Turning back to FIG. 1, upon creation of the meeting invitation templates 130(1)-130(3), the scheduling server 105 may automatically determine a triggering condition for one of the meeting invitation templates 130(1)-130(3) (e.g., meeting invitation template 130(1)) based on machine learning or rules-based techniques (e.g., artificial intelligence, analytics, predefined business rules, etc.). A triggering condition may be a condition that indicates that a meeting should be offered to a contact.

For example, the scheduling server 105 may determine that prospective customers tend to convert to current customers within three days following a meeting with a particular topic expert, and that a sixty minute virtual meeting between the converted customer and a designated customer success representative within the same time-zone as the converted customer should be initiated within one day of the conversion. Here, the scheduling server 105 automatically (or based on user instructions) determines that the conversion is a triggering condition for meeting invitation template 130(1), which in this example is a meeting invitation template for the sixty minute virtual meeting. For example, the CRM system 100/scheduling server 105 may initiate a meeting in response to determining that the meeting with the particular topic expert took place, and/or based on a notification that the customer has been converted.

The scheduling server 105 may record data to track which previous meetings have been scheduled/accepted/rejected/etc. by each meeting attendee, and may analyze the data to further understand and refine the triggering condition. These techniques may provide the ability to proactively connect the organization to a current/prospective customer based on predictive analytics (e.g., based on an analysis of the relationship between the customer and the organization).

The scheduling server 105 may determine that the triggering condition for the meeting invitation template has occurred and, in response to the triggering condition occurring, send, to a meeting invitee, a scheduling page that identifies the multiple options for the parameter of the meeting. This may involve defining certain internal resources to be available for a meeting of a particular type.

The parameter of the meeting may include, for example, purpose, time, and meeting attendees, as well as meeting service provider. In one example, the scheduling server 105 automatically determines an availability of the meeting invitee based on a calendar (e.g., calendar 120(2)) of the meeting invitee, and an availability of a meeting organizer based on a calendar (e.g., calendar 120(1)) of the meeting organizer. In this example, the multiple options for the parameter of the meeting include potential dates and times of the meeting during which both the meeting invitee and the meeting organizer are available.

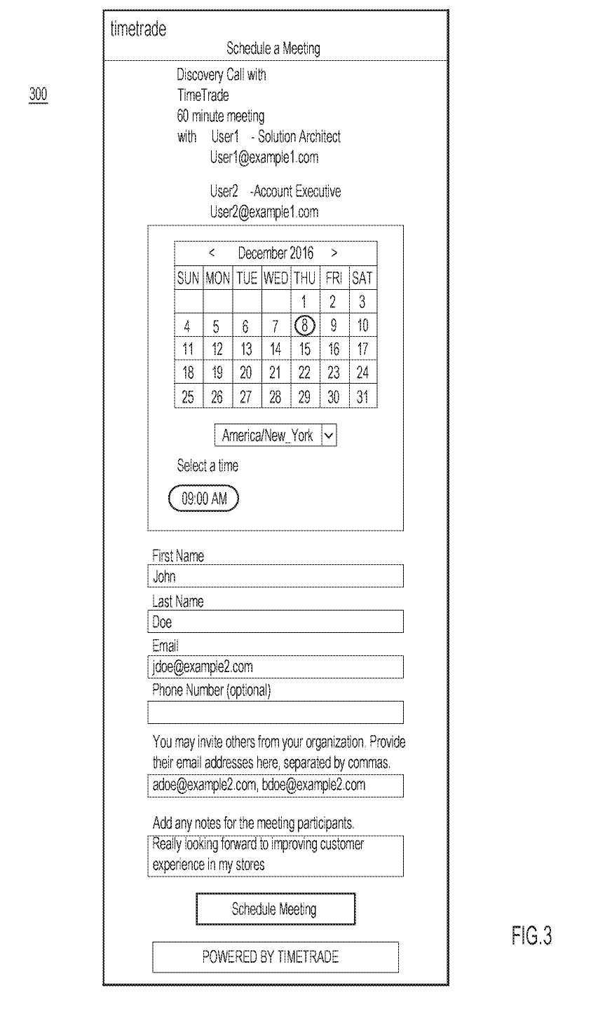

FIG. 3 illustrates an example publically-facing scheduling page 300. The scheduling page 300 may be a configurable meeting invitation based on/generated from the meeting invitation template 130(1). That is, the scheduling page 300 permits the external meeting attendee to configure the parameters of the meeting in accordance with the options for the parameters that were identified in corresponding meeting invitation template 130(1). Thus, the meeting attendee may schedule the meeting based on the options for the parameters for the meeting, as defined in the meeting invitation template 130(1). In another example, the scheduling page 300 may be based on the create meeting invitation page 200.

The scheduling page 300 defines meeting criteria/attendees and allows the external meeting attendee to select a date and time (for example) for the meeting that is available for all meeting attendees. The external meeting attendee may make an application programming interface (API) call via software to display the real-time availability of all resources/meeting attendees (e.g., using calendar connectors). The external meeting attendee may select the most convenient time based on the display. Once selected, the external meeting attendee may provide any other meeting information and may invite others in the organization to the meeting.

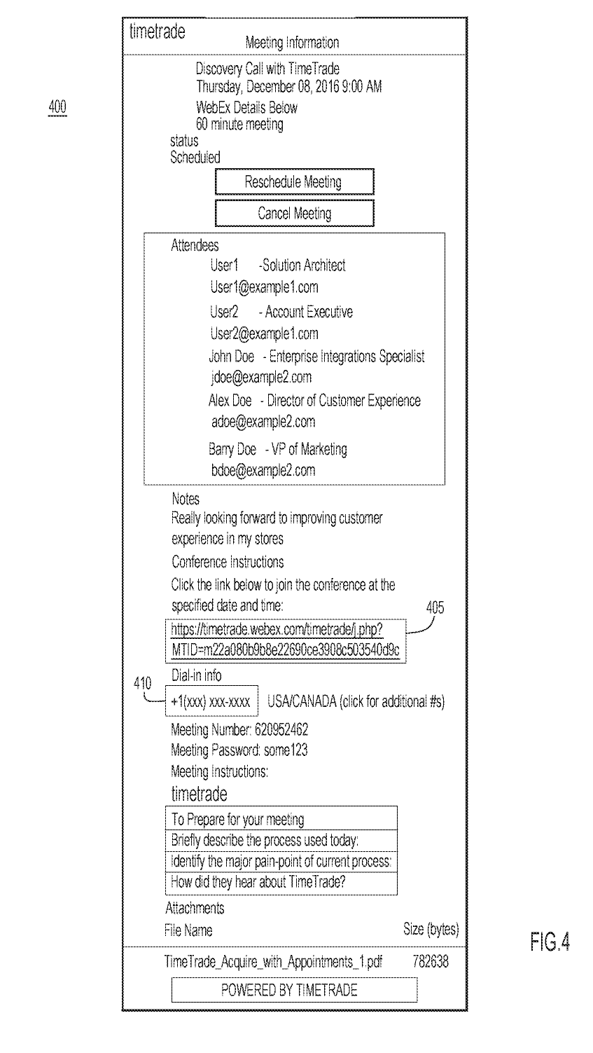

The scheduling server 105 may receive a notification that the meeting invitee has selected an option of the multiple options for the parameter of the meeting, and redirect the meeting invitee to a meeting status page that provides a link to the meeting. For example, once the external meeting attendee schedules the meeting, the scheduling page 300 may redirect the external meeting attendee to a meeting status page 400, as shown in FIG. 4. The meeting status page 400 may provide meeting information, including a conference link 405 and conference line information 410. Conference link 405 and conference line information 410 may be embedded within the meeting status page 400. Conference line information 410 may be a unique conference line to allow the meeting attendees to call in to the meeting. In the event of subsequent changes to the meeting, meeting status page 400 may update accordingly, and the external meeting attendee may refer to this page for the updates.

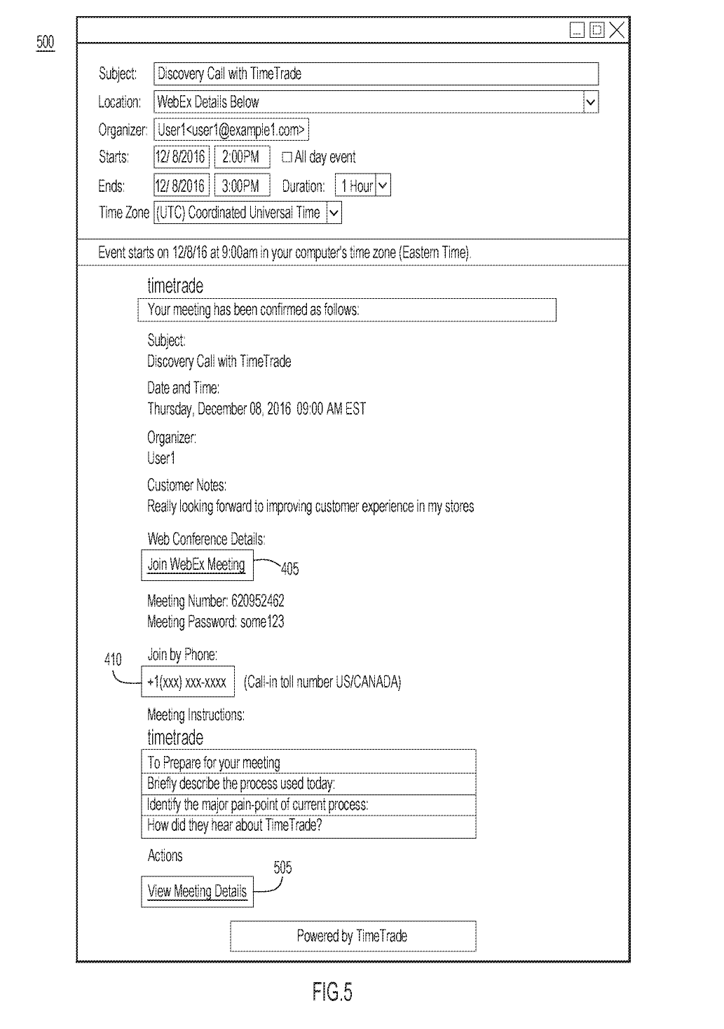

The scheduling server 105 may automatically schedule the meeting in calendars 120(1)-120(4). In one example, the scheduling server 105 sends an electronic invitation (e.g., email, text message, etc.) for the meeting with the selected options. An example electronic invitation 500 is shown in FIG. 5. The electronic invitation 500 may include the conference link 405, conference line information 410, and a meeting status page link 505 (i.e., a link to the meeting status page 400).

By sending an electronic invitation, the parties are automatically informed of the scheduled meeting time and other parameters. Accordingly, the electronic invitation 500 may include information related to the purpose, time, and meeting attendees, as well as meeting service provider 115(1). When the meeting attendees join the meeting, the scheduling server 105 may automatically authenticate via stored user credentials (e.g., the user credentials included in the meeting invitation template 130(1)) to allow the meeting attendees to virtually share information (e.g., via sharing screens, chatting, etc.).

Conventionally, meeting attendees often book a meeting on a calendar, forget to include conference information, and subsequently send an email with the conference details. Because the actual event on the calendar does not include the conference details, the meeting attendees must separately locate the conference details in the email. By contrast, the electronic invitation 500 includes the conference link 405 and meeting status page link 505 to the meeting status page 400, and is automatically saved directly to calendars 110(1)-110(4).

The scheduling server 105 may automatically schedule the meeting with meeting service provider 115(1) (e.g., via API). The scheduling server 105 may provide previously stored user credentials to allow the meeting provider 115(1) to dynamically create a unique virtual conference space for the meeting. This enables meeting service provider 115(1) to supply, via API, a unique Uniform Resource Locator (URL) for the conference link 405, conference line information 410, etc. to the scheduling server 105. The scheduling server 105 may use this URL to provide the conference link 405 (FIGS. 4 and 5).

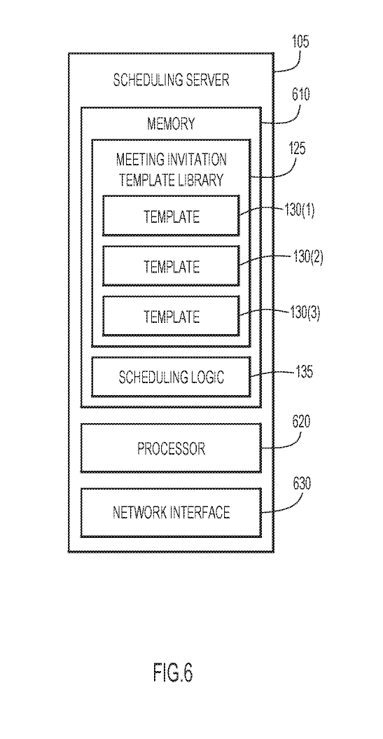

FIG. 6 is a simplified block diagram of scheduling server 105 configured to implement the techniques presented herein. In this example, the scheduling server 105 includes a memory 610, one or more processors 620, and a network interface 630. Memory 610 stores the meeting invitation template library 125, including meeting invitation templates 130(1)-130(3), and instructions for scheduling logic 135.

The one or more processors 620 are configured to execute instructions stored in the memory 610 for the scheduling logic 135. When executed by the one or more processors 620, the scheduling logic 135 causes the scheduling server 105 to perform operations described herein. The network interface 630 is a network interface card (or multiple instances of such a device) or other network interface device that enables network communications on behalf of the scheduling server 105 for sending and receiving messages as described above.

The memory 610 may be read only memory (ROM), random access memory (RAM), magnetic disk storage media devices, optical storage media devices, flash memory devices, electrical, optical, or other physical/tangible memory storage devices. Thus, in general, the memory 610 may be one or more tangible (non-transitory) computer readable storage media (e.g., a memory device) encoded with software comprising computer executable instructions and when the software is executed (by the processor 620) it is operable to perform the operations described herein.

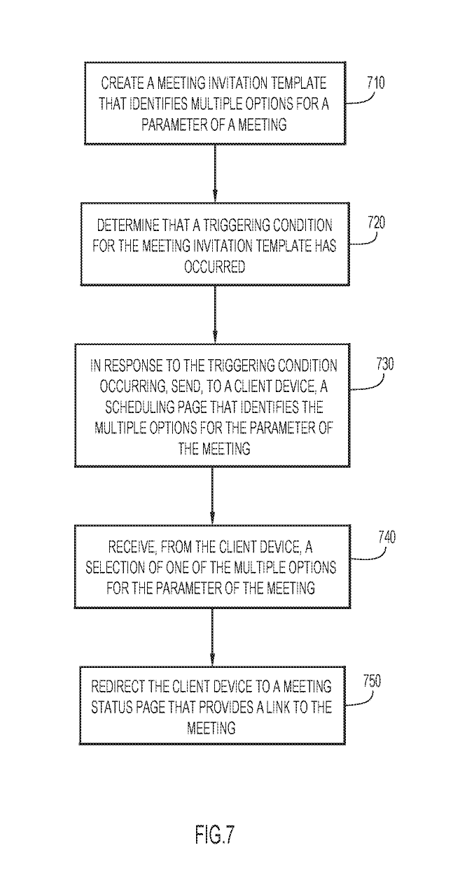

FIG. 7 is a flowchart of an example method for automated appointment scheduling. This method may be performed by one or more servers (e.g., scheduling server 105). At 710, the server creates a meeting invitation template that identifies multiple options for a parameter of a meeting. At 720, the server determines that a triggering condition for the meeting invitation template has occurred. At 730, in response to the triggering condition occurring, the server sends, to a client device, a scheduling page that identifies the multiple options for the parameter of the meeting. At 740, the server receives, from the client device, a selection of one of the multiple options for the parameter of the meeting. At 750, the server redirects the client device to a meeting status page that provides a link to the meeting.

Techniques described herein allow for meetings to be created automatically in response to certain events, without requiring any user input. This reduces the amount of time required by users to input parameters into a CRM system, thereby saving processing time and efficiency. This may increase performance over a network, particularly for organizations with hundreds of users.

Conventionally, users are required to create meetings using multiple systems including email, CRM, web conferencing, document management, etc. On a mobile device, for example, the effort to navigate these multiple systems and switch between screens to compile the necessary information is inefficient from a systems perspective and negatively impacts performance.

Moreover, generating web conferencing capabilities via API (as described herein) is inherently more secure for organizations because this generally requires an API key. Thus, administrators may more easily control access to a subscribed service and/or to the CRM system. For example, the CRM system may utilize access controls (e.g., “Do not allow CRM access after 9:00 pm.”).

Collaboration between an organization and a customer contact improves when the customer has insight into the meeting times during which all attendees are free to meet. However, state-of-the-art meeting scheduling often requires initiation by an organization. Thus, the organization may need insight into the overall status of the customer. The organization also needs to actively understand not only when the appointment needs to be offered, but also which organization representatives should attend the meeting.

Further, the ability to coordinate all activities within a single screen in a CRM system increases the efficiency of appointment/meeting scheduling (e.g., between resources at an organization and a contact). However, users implementing conventional techniques often navigate between various calendars/systems (e.g., a personal calendar, a CRM system, a web conferencing system, etc.) to enter similar inputs into each calendar/system. These users may then manually consolidate the information into a single email.

The techniques described herein enable the appointment process to be automated in a proactive manner, instead of relying upon users to create the meeting. CRM process functionality linking automated intelligence may generate appointment templates that enable a CRM system to proactively automate appointment scheduling based on business rules and predictive analytics calculated within the CRM system. The CRM system may automatically produce an electronic invitation that includes conferencing capabilities. The conferencing capabilities may be automatically generated when the invitation is created.

A single mechanism may integrate multiple conference services connected via APIs. Authentication techniques significantly reduce resources needed to schedule an appointment/meeting. Sales, marketing, and/or service organizations may implement the techniques described herein, which may be a central cornerstone to the CRM system of an organization and integral to sales and support. The user may further integrate the meeting with pre-existing business rules and workflows in the CRM system to automatically schedule meetings. The CRM system may also generate, e.g., reports based on these automatically scheduled meetings. System/machine learning and automated intelligence mechanisms may assist the user and automate the workflow by proactively generating electronic invitations that include a preferred meeting service provider.

Using these techniques, a user may easily integrate web conferencing capabilities including one or more of the following features. First, the user may integrate user web conferencing authentication capabilities within the CRM system, thereby avoiding separately gathering web conferencing details via a third party application. Second, the user may retrieve the web conferencing capability within the CRM system (e.g., via API integration) in order to request and retrieve a custom web conference for each selected meeting. Third, the user may automatically include the custom web conference as a core data field in the parameters of the meeting invitation/meeting invitation template, thereby allowing meeting attendees to retrieve web conferencing information as part of the meeting.

In one form, a computer-implemented method is provided. The computer-implemented method is performed by a scheduling server and comprises: creating a meeting invitation template that identifies multiple options for a parameter of a meeting; determining that a triggering condition for the meeting invitation template has occurred; in response to the triggering condition occurring, sending, to a client device, a scheduling page that identifies the multiple options for the parameter of the meeting; receiving, from the client device, a selection of one of the multiple options for the parameter of the meeting; and redirecting the client device to a meeting status page that provides a link to the meeting.

In another form, an apparatus is provided. The apparatus comprises: memory configured to store a meeting invitation template that identifies multiple options for a parameter of a meeting; a network interface that enables network communications on behalf of the apparatus; and a processor communicatively coupled to the memory and the network interface, wherein the processor is configured to: create the meeting invitation template; determine that a triggering condition for the meeting invitation template has occurred; in response to the triggering condition occurring, send, to a client device, a scheduling page that identifies the multiple options for the parameter of the meeting; receive, from the client device, a selection of one of the multiple options for the parameter of the meeting; and redirect the client device to a meeting status page that provides a link to the meeting.

In another form, one or more non-transitory computer readable storage media are provided. The non-transitory computer readable storage media are encoded with computer executable instructions that, when executed by a processor, cause the processor to: create a meeting invitation template that identifies multiple options for a parameter of a meeting; determine that a triggering condition for the meeting invitation template has occurred; in response to the triggering condition occurring, send, to a client device, a scheduling page that identifies the multiple options for the parameter of the meeting; receive, from the client device, a selection of one of the multiple options for the parameter of the meeting; and redirect the client device to a meeting status page that provides a link to the meeting.

The above description is intended by way of example only. Although the techniques are illustrated and described herein as embodied in one or more specific examples, it is nevertheless not intended to be limited to the details shown, since various modifications and structural changes may be made within the scope and range of equivalents of the claims.

What is claimed is:

1. A computer-implemented method performed by a scheduling server comprising:
creating a meeting invitation template that identifies multiple options for a parameter of a meeting;
determining that a triggering condition for the meeting invitation template has occurred;
in response to the triggering condition occurring, sending, to a client device, a scheduling page that identifies the multiple options for the parameter of the meeting;
receiving, from the client device, a selection of one of the multiple options for the parameter of the meeting; and
redirecting the client device to a meeting status page that provides a link to the meeting.

2. The method of claim 1, wherein the meeting invitation template further identifies a particular meeting service provider of a plurality of meeting service providers to host the meeting.

3. The method of claim 2, further comprising:
automatically scheduling the meeting with the particular meeting service provider.

4. The method of claim 2, further comprising:
storing user credentials that cause the particular meeting service provider to host the meeting.

5. The method of claim 1, wherein the meeting invitation template is one of a plurality of meeting invitation templates, the method further comprising:
storing the plurality of meeting invitation templates.

6. The method of claim 1, further comprising:
automatically determining an availability of a meeting invitee based on a calendar application of the meeting invitee; and
automatically determining an availability of a meeting organizer based on a calendar application of the meeting organizer, wherein
the multiple options for the parameter of the meeting include potential dates and times of the meeting during which both the meeting invitee and the meeting organizer are available.

7. The method of claim 1, further comprising:
automatically determining the triggering condition based on machine learning or rules-based techniques.

8. An apparatus comprising:
memory configured to store a meeting invitation template that identifies multiple options for a parameter of a meeting;
a network interface that enables network communications on behalf of the apparatus; and
a processor communicatively coupled to the memory and the network interface, wherein the processor is configured to:
create the meeting invitation template;
determine that a triggering condition for the meeting invitation template has occurred;
in response to the triggering condition occurring, send, to a client device, a scheduling page that identifies the multiple options for the parameter of the meeting;
receive, from the client device, a selection of one of the multiple options for the parameter of the meeting; and
redirect the client device to a meeting status page that provides a link to the meeting.

9. The apparatus of claim 8, wherein the meeting invitation template further identifies a particular meeting service provider of a plurality of meeting service providers to host the meeting.

10. The apparatus of claim 9, wherein the processor is further configured to:
automatically schedule the meeting with the particular meeting service provider.

11. The apparatus of claim 9, wherein the processor is further configured to:
store user credentials that cause the particular meeting service provider to host the meeting.

12. The apparatus of claim 8, wherein the meeting invitation template is one of a plurality of meeting invitation templates, and wherein the processor is further configured to:
store the plurality of meeting invitation templates.

13. The apparatus of claim 8, wherein the processor is further configured to:
automatically determine an availability of a meeting invitee based on a calendar application of the meeting invitee; and
automatically determine an availability of a meeting organizer based on a calendar application of the meeting organizer, wherein
the multiple options for the parameter of the meeting include potential dates and times of the meeting during which both the meeting invitee and the meeting organizer are available.

14. The apparatus of claim 8, wherein the processor is further configured to:
automatically determine the triggering condition based on machine learning or rules-based techniques.

15. One or more non-transitory computer readable storage media encoded with computer executable instructions that, when executed by a processor, cause the processor to:
create a meeting invitation template that identifies multiple options for a parameter of a meeting;
determine that a triggering condition for the meeting invitation template has occurred;
in response to the triggering condition occurring, send, to a client device, a scheduling page that identifies the multiple options for the parameter of the meeting;
receive, from the client device, a selection of one of the multiple options for the parameter of the meeting; and
redirect the client device to a meeting status page that provides a link to the meeting.

16. The one or more non-transitory computer readable storage media of claim 15, wherein the meeting invitation template further identifies a particular meeting service provider of a plurality of meeting service providers to host the meeting.

17. The one or more non-transitory computer readable storage media of claim 16, wherein the instructions further cause the processor to:
automatically schedule the meeting with the particular meeting service provider.

18. The one or more non-transitory computer readable storage media of claim 16, wherein the instructions further cause the processor to:
store user credentials that cause the particular meeting service provider to host the meeting.

19. The one or more non-transitory computer readable storage media of claim 15, wherein the meeting invitation template is one of a plurality of meeting invitation templates, and wherein the instructions further cause the processor to:
store the plurality of meeting invitation templates.

20. The one or more non-transitory computer readable storage media of claim 15, wherein the instructions further cause the processor to:
automatically determine an availability of a meeting invitee based on a calendar application of the meeting invitee; and
automatically determine an availability of a meeting organizer based on a calendar application of the meeting organizer, wherein
the multiple options for the parameter of the meeting include potential dates and times of the meeting during which both the meeting invitee and the meeting organizer are available.
